(19) United States
(12) Patent Application Publication
(10) Pub. No.: US 2006/0038044 A1
(43) Pub. Date: Feb. 23, 2006

(54) Replaceable throat insert for a kinetic spray nozzle

(76) Inventors: Thomas Hubert Van Steenkiste, Ray, MI (US); Daniel William Gorkiewicz, Washington, MI (US)

Correspondence Address: SCOTT A. MCBAIN;DELPHI TECHNOLOGIES, INC., Legal Staff, P.O. Box 5052, Mail Code: 480-410-202, Troy, MI, 48007-5052, US

(21) Appl. No.: 10/924,338

(22) Filed: Aug. 23, 2004

(51) Int. Cl. B05B 1/04

(52) U.S. Cl. 239/594

(57) ABSTRACT

A converging diverging supersonic nozzle for a kinetic spray system is disclosed. In one embodiment, the supersonic nozzle has a first end opposite an exit end and a diverging region adjacent the exit end. A removable throat insert has an entrance cone and a throat and is received in the first end with the throat positioned adjacent the diverging region. In another embodiment, the removable throat insert has an entrance cone, a diverging region and a throat positioned between the entrance cone and the diverging region. The disclosed replaceable throat inserts address the problem of excessive wear in the throat relative to the rest of the supersonic nozzle which has plagued other kinetic spray systems. With the disclosed inserts a worn throat can rapidly and economically be replaced while saving the rest of the supersonic nozzle.

### TECHNICAL FIELD

The present invention is directed toward a kinetic spray process, and more particularly, to an improved kinetic spray nozzle having a removable throat insert.

### RELATED APPLICATIONS

NONE.

### INCORPORATION BY REFERENCE

U.S. Pat. No. 6,139,913, “Kinetic Spray Coating Method and Apparatus,” and U.S. Pat. No. 6,283,386 “Kinetic Spray Coating Apparatus” are incorporated by reference herein.

### BACKGROUND OF THE INVENTION

A new technique for producing coatings on a wide variety of substrate surfaces by kinetic spray, or cold gas dynamic spray, was recently reported in two articles by T. H. Van Steenkiste et al. The first was entitled “Kinetic Spray Coatings,” published in Surface and Coatings Technology, vol. 111, pages 62-71, Jan. 10, 1999 and the second was entitled “Aluminum coatings via kinetic spray with relatively large powder particles”, published in Surface and Coatings Technology 154, pp. 237-252, 2002. The articles discuss producing continuous layer coatings having high adhesion, low oxide content and low thermal stress. The articles describe coatings being produced by entraining metal powders in an accelerated gas stream, through a converging-diverging de Laval type nozzle and projecting them against a target substrate surface. The particles are accelerated in the high velocity gas stream by the drag effect. The gas used can be any of a variety of gases including air or helium. It was found that the particles that formed the coating did not melt or thermally soften prior to impingement onto the substrate. It is theorized that the particles adhere to the substrate when their kinetic energy is converted to a sufficient level of thermal and mechanical deformation upon striking the substrate. Thus, it is believed that the particle velocity must exceed a critical velocity high enough to exceed the yield stress of the particle to permit it to adhere when it strikes the substrate. It was found that the deposition efficiency of a given particle mixture was increased as the inlet air temperature was increased. Increasing the inlet air temperature decreases its density and thus increases its velocity. The velocity varies approximately as the square root of the inlet air temperature. The actual mechanism of bonding of the particles to the substrate surface is not fully known at this time. The critical velocity is dependent on the material of the particle and the material of the substrate. Once an initial layer of particles has been formed on a substrate subsequent particles bind not only to the voids between previous particles bound to the substrate but also engage in particle to particle bonds. The bonding process is not due to melting of the particles in the main gas stream because the temperature of the particles is always below their melting temperature.

One problem all prior art kinetic spray systems has been wear of the throat portion of the with converging-diverging de Laval type nozzle. Because of the restriction to flow caused by the throat it enlarges with use as the sprayed particles abrade the throat. In fact, the wear rate is approximately 10 fold faster in the throat than in the rest of the nozzle. The system can compensate for the wear up to a point by varying the spray parameters, but there is a limit to the amount the parameters can be varied. When the limit is reached the entire nozzle must be scrapped. The nozzles are expensive to produce because of the extensive machining that is required to form the nozzle. Thus, it would be advantageous to develop a nozzle having a replaceable throat region to permit the nozzle to be used for much longer periods of time and at a lower cost.

### SUMMARY OF THE INVENTION

In one embodiment, the present invention is a converging diverging supersonic nozzle for a kinetic spray system comprising: a supersonic nozzle comprising a first end opposite an exit end and a diverging region adjacent the exit end; a removable throat insert comprising an entrance cone and a throat; and the removable throat insert received in the first end with the throat positioned adjacent the diverging region.

In another embodiment, the present invention is a converging diverging supersonic nozzle for a kinetic spray system comprising: a supersonic nozzle comprising a first end opposite an exit end and a diverging region adjacent the exit end; a removable throat insert comprising an entrance cone, a diverging region and a throat positioned between the entrance cone and the diverging region; and the removable throat insert received in the first end with the diverging region of the insert positioned adjacent the diverging region of the nozzle.

In another embodiment the present invention is a replaceable throat insert for a supersonic nozzle comprising: an entrance cone and a throat, the insert removably receivable in a first end of a supersonic nozzle.

In another embodiment, the present invention is a replaceable throat insert for a supersonic nozzle comprising: an entrance cone, a throat, and a diverging region with the throat positioned between the converging region and the diverging region, the insert removably receivable in a first end of a supersonic nozzle.

### BRIEF DESCRIPTION OF THE DRAWINGS

FIG. 1 is a schematic diagram of a kinetic spray system according to the present invention;

FIG. 2 is a cross-sectional view of one embodiment of a supersonic nozzle for use in the kinetic spray system of FIG. 1; and

FIG. 3 is a cross-sectional view of another embodiment of a supersonic nozzle for use in the kinetic spray system of FIG. 1.

### DESCRIPTION OF A PREFERRED EMBODIMENT

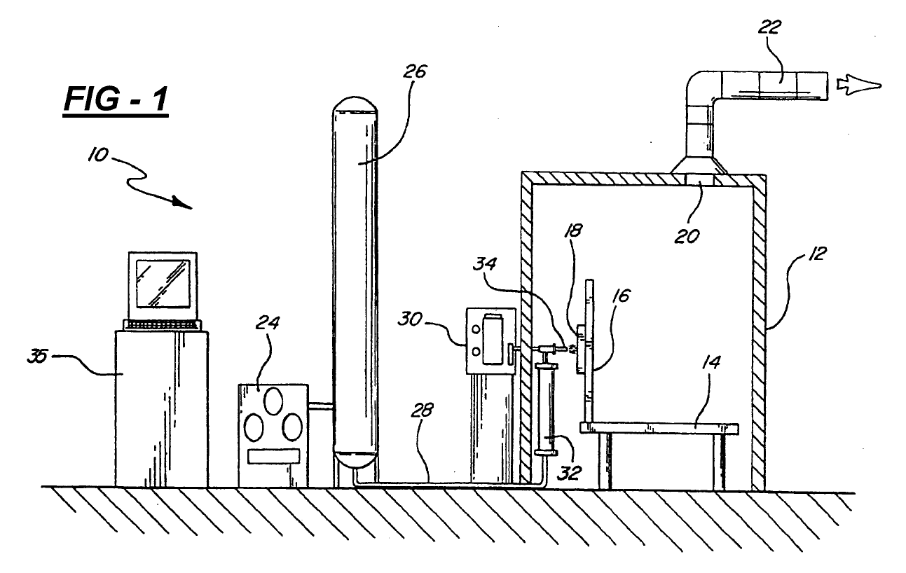

Referring first to FIG. 1, a kinetic spray system according to the present invention is generally shown at 10. System 10 includes an enclosure 12 in which a support table 14 or other support means is located. A mounting panel 16 fixed to the table 14 supports a work holder 18 capable of movement in three dimensions and able to support a suitable workpiece formed of a substrate material to be coated. Work holder 18 can also be designed to feed the substrate past a kinetic spray nozzle 34 during a coating operation. The enclosure 12 includes surrounding walls having at least one air inlet, not shown, and an air outlet 20 connected by a suitable exhaust conduit 22 to a dust collector, not shown. During coating operations, the dust collector continually draws air from the enclosure 12 and collects any dust or particles contained in the exhaust air for subsequent disposal.

The spray system 10 further includes a gas compressor 24 capable of supplying gas pressure up to 3.4 MPa (500 psi) to a high pressure gas ballast tank 26. The gas ballast tank 26 is connected through a line 28 to powder feeder 30 and a separate gas heater 32. The powder feeder 30 can either be a high pressure powder feeder or a low pressure feeder as described below. The gas heater 32 supplies high pressure heated gas, the main gas described below, to a kinetic spray nozzle 34. It is possible to provide the nozzle 34 with movement capacity in three directions in addition to or rather than the work holder 18. The pressure of the main gas generally is set at from 100 to 500 psi. The powder feeder 30 mixes particles of a spray powder with the gas at a desired pressure and supplies the mixture of particles to the nozzle 34. A computer control 35 operates to control the pressure of the gas supplied to the powder feeder 30, the pressure of gas supplied to the gas heater 32, the temperature of the gas supplied to the powder feeder 30, and the temperature of the heated main gas exiting the gas heater 32. Useful gases include air, nitrogen, helium and others.

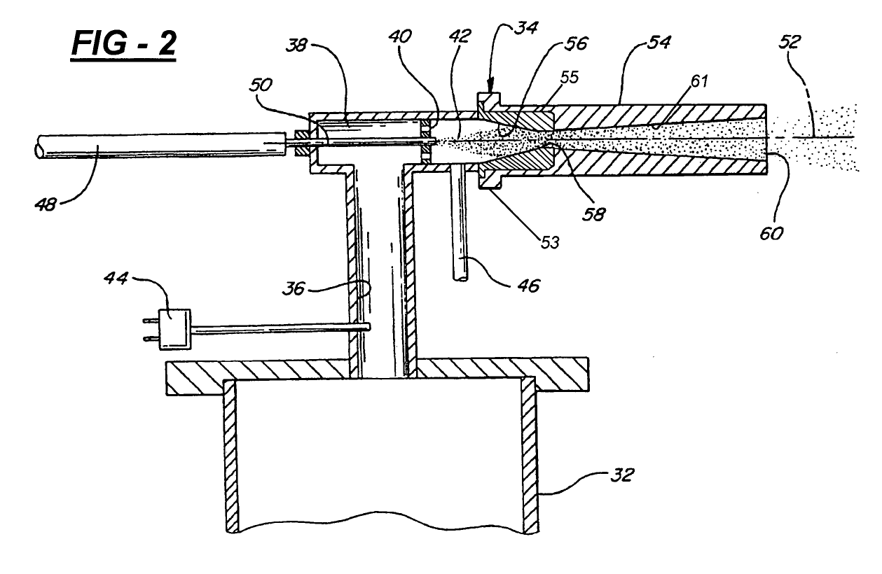

FIG. 2 is a cross-sectional view of one embodiment of the nozzle 34 and its connections to the gas heater 32 and a high pressure powder feeder 30. A main gas passage 36 connects the gas heater 32 to the nozzle 34. Passage 36 connects with a premix chamber 38 that directs the main gas through a flow straightener 40 and into a chamber 42. Temperature and pressure of the heated main gas are monitored by a gas inlet temperature thermocouple 44 in the passage 36 and a pressure sensor 46 connected to the chamber 42. The main gas has a temperature that is always insufficient to cause melting in the nozzle 34 of any particles being sprayed. The main gas temperature can range from 200 to 3000° F. The main gas temperature can be well above the melt temperature of the particles. Main gas temperatures that are 5 to 7 fold above the melt temperature of the particles have been used in the present system 10. What is necessary is that the temperature and exposure time to the main gas be selected such that the particles do not melt in the nozzle 34. The temperature of the gas rapidly falls as it travels through the nozzle 34. In fact, the temperature of the gas measured as it exits the nozzle 34 is often at or below room temperature even when its initial temperature is above 1000° F.

Chamber 42 is in communication with a de Laval type supersonic nozzle 54. The nozzle 54 has a central axis 52 and a throat insert 55. In this embodiment, the throat insert 55 has an entrance cone 56 that decreases in diameter to a throat 58. The entrance cone 56 forms a converging region of the insert 55. Downstream of the throat 58 the supersonic nozzle 54 has an exit end 60 and a diverging region 61 of the supersonic nozzle 54 is defined between the throat 58 and the exit end 60. The largest interior diameter of the entrance cone 56 may range from 10 to 6 millimeters, with 7.5 millimeters being preferred. The entrance cone 56 narrows to the throat 58. The throat 58 may have an interior diameter of from 6 to 1 millimeters, with from 4 to 2 millimeters being preferred. The throat insert 55 is preferably formed from a hardened wear resistant material such as an alloy, a hard metal like titanium, or a ceramic. In addition, the throat insert can be formed from a softer alloy or metal that is subsequently hardened using a nitriding process as is known in the art of metallurgy. The ceramic insert 55 can be formed in many ways including by injection casting or by using a machinable ceramic that is later fired to harden it as is known in the art. The throat insert 55 is slip fit into a first end 53 of the supersonic nozzle 54 opposite the exit end 60. In this embodiment, preferably the throat insert 55 ends after the throat 58. The throat insert 55 allows for rapid replacement of the insert 55 when it becomes worn without the need to replace the entire nozzle 54 as in the prior art. The diverging region 61 of the nozzle 54 from downstream of the throat 58 to the exit end 60 may have a variety of shapes, but in a preferred embodiment it has a rectangular cross-sectional shape that increases in area from the throat 58 to the exit end 60. At the exit end 60 the nozzle 54 preferably has a rectangular interior shape with a long dimension of from 8 to 14 millimeters by a short dimension of from 2 to 6 millimeters. The diverging region 61 can have a length of from about 100 millimeters to about 400 millimeters. The diverging region 61 downstream from the throat 58, is a region of reduced main gas pressure, the pressure of the main gas falls as it travels down the diverging region 61 and can fall below atmospheric pressure.

In this embodiment the injector tube 50 is aligned with the central axis 52. An inner diameter of the injector tube 50 can vary between 0.4 to 3.0 millimeters. The nozzle 54 produces an exit velocity of the entrained particles of from 300 meters per second to as high as 1200 meters per second. The entrained particles gain kinetic and thermal energy during their flow through this nozzle 54. It will be recognized by those of skill in the art that the temperature of the particles in the gas stream will vary depending on the particle size, particle material, and the main gas temperature. The main gas temperature is defined as the temperature of heated high-pressure gas at the inlet to the nozzle 54. Since these temperatures are chosen so that they heat the particles to a temperature that is less than the melting temperature of the particles, even upon impact, there is no change in the solid phase of the original particles due to transfer of kinetic and thermal energy, and therefore no change in their original physical properties. The particles themselves are always at a temperature below their melt temperature. The particles exiting the nozzle 54 are directed toward a surface of a substrate to coat it.

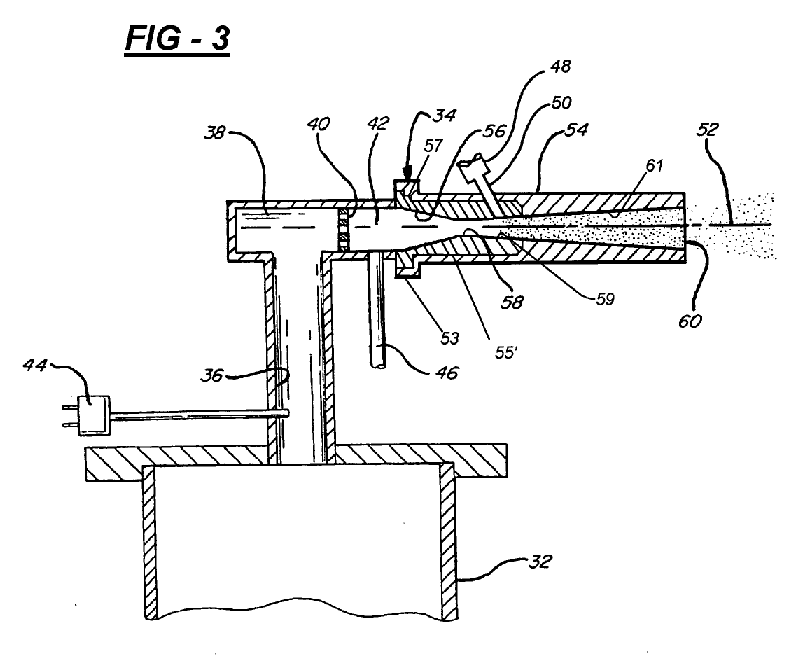

FIG. 3 is a cross-sectional view of another embodiment of the nozzle 34 and its connections to the gas heater 32 and a low pressure powder feeder 30. This nozzle 34 differs from that in FIG. 2 in several ways. First, it is connected to a low pressure powder feeder 30 rather than a high pressure one. Second the throat insert 55′ has an entrance cone 56 that narrows to a throat 58 and after the throat 58 there is a diverging region 59 of the insert 55′. Finally, the supplement inlet line 48 connects to an injector tube 50 that supplies the particles to the nozzle 54 in the diverging region 59 of the insert 55′ downstream from the throat 58. The diverging region 59 of the insert 55′ transitions and mates to the diverging region 61 of the nozzle 54. The insert 55′ is formed in the manner and from the materials described above with respect to FIG. 2. The diverging regions 59 and 61 are regions of reduced main gas pressure and their interior dimensions mate to each other to form a smooth transition. The main gas passage 36 connects the gas heater 32 to the nozzle 34. Passage 36 connects with a premix chamber 38 that directs the main gas through a flow straightener 40 and into a chamber 42. Temperature and pressure of the heated main gas are monitored by the gas inlet temperature thermocouple 44 in the passage 36 and the pressure sensor 46 connected to the chamber 42. The main gas has a temperature that is always insufficient to cause melting in the nozzle 34 of any particles being sprayed. The main gas temperature can range from 200 to 3000° F. The main gas temperature can be well above the melt temperature of the particles. Main gas temperatures that are 5 to 7 fold above the melt temperature of the particles have been used in the present system 10. What is necessary is that the temperature and exposure time to the main gas be selected such that the particles do not melt in the nozzle 34. The temperature of the gas rapidly falls as it travels through the nozzle 34. In fact, the temperature of the gas measured as it exits the nozzle 34 is often at or below room temperature even when its initial temperature is above 1000° F. In prior art low pressure kinetic spray systems without the insert 55′ of the present invention the inside of the diverging region 61 of the nozzle 54 has suffered from accelerated wearing in the area opposite the injector tube 50. The present invention corrects this problem by providing an easy replacement were the wear is transferred to the diverging region 59 and the insert 55′ can quickly be exchanged.

Chamber 42 is in communication with the de Laval type supersonic nozzle 54. The nozzle 54 has a central axis 52 and the throat insert 55′. The throat insert 55′ entrance cone 56 decreases in diameter to a throat 58. An alignment feature 57 on the insert 55′ ensures that the insert 55′ will accommodate the injector tube 50. The alignment feature 57 can be a key and slot arrangement, a peg or other known in the art arrangements. The entrance cone 56 forms the converging region of the throat insert 55′. Downstream of the throat 58 the diverging region 59 of the insert 55′ mates to the diverging region 61 of the nozzle 54. The diverging region 61 ends at the exit end 60. The insert 55′ is slip fit into the first end 53 of the nozzle 54 opposite the exit end 60. The largest interior diameter of the entrance cone 56 may range from 10 to 6 millimeters, with 7.5 millimeters being preferred. The entrance cone 56 narrows to the throat 58. The throat 58 may have an interior diameter of from 6 to 1 millimeters, with from 4 to 2 millimeters being preferred. The diverging region 59 of the insert 55′ may have a length of from 10 to 300 millimeters, more preferably from 20 to 250 millimeters. The diverging region 59 of the throat insert 55′ needs to be long enough to extend beyond the point of injection of the powder particles. The diverging regions 59 and 61 of the insert 55′ and of the nozzle 54 mate and may have a variety of shapes, but in a preferred embodiment they have a rectangular cross-sectional shape. At the exit end 60 the nozzle 54 preferably has a rectangular interior shape with a long dimension of from 8 to 14 millimeters by a short dimension of from 2 to 6 millimeters.

The injector tube 50 is inserted through aligning holes (not shown) in the nozzle 54 and the insert 55′. The alignment feature 57 ensures that the holes are correctly aligned when the insert 55′ is fitted into the nozzle 54 to allow for insertion of the tube 50. The angle of the injector tube 50 relative to the central axis 52 can be any that ensures that the particles are directed toward the exit end 60, basically from 1 to about 90 degrees. It has been found that an angle of 45 degrees relative to central axis 52 works well. An inner diameter of the injector tube 50 can vary between 0.4 to 3.0 millimeters.

Using a nozzle 54 having a length of 300 millimeters from throat 58 to exit end 60, a throat 58 diameter of 2 millimeters and an exit end 60 with a rectangular opening of 5 by 12.5 millimeters and beginning with a main gas pressure of 300 psi the measured pressures were 14.5 psi at 1 inch after the throat 58, 20 psi at 2 inches from the throat 58, 12.8 psi at 3 inches from the throat 58, 9.25 psi at 4 inches from the throat 58, 10 psi at 5 inches from the throat 58 and below atmospheric pressure beyond 6 inches from the throat 58. The rate at which the main gas pressure decreases is a function of the cross-sectional area of the throat 58 and the cross-sectional area of the diverging region 59 at the point of injection. With a larger throat 58 and the same cross-sectional area of the diverging region 59 the main gas pressure stays above atmospheric for a longer distance. What is necessary is that the powder particles be injected at a point after the throat 58 and before the main gas pressure falls below atmospheric pressure so one always uses a positive pressure in the powder feeder 30. This embodiment allows one to use much lower pressures to inject the powder when the injection takes place after the throat 58. The low pressure powder feeder 30 of the present invention has a cost that is approximately ten-fold lower than the high pressure powder feeder used with the nozzle 34 of FIG. 2. Generally, the low pressure powder feeder 30 is used at a pressure of 100 psi to 5 psi. All that is required is that it exceeds the main gas pressure at the point of injection and that the main gas pressure be above atmospheric.

The nozzle 54 produces an exit velocity of the entrained particles of from 300 meters per second to as high as 1200 meters per second. The entrained particles gain kinetic and thermal energy during their flow through this nozzle 54. It will be recognized by those of skill in the art that the temperature of the particles in the gas stream will vary depending on the particle size, particle material, and the main gas temperature. The main gas temperature is defined as the temperature of heated high-pressure gas at the inlet to the nozzle 54. Since these temperatures are chosen so that they heat the particles to a temperature that is less than the melting temperature of the particles, even upon impact, there is no change in the solid phase of the original particles due to transfer of kinetic and thermal energy, and therefore no change in their original physical properties. The particles themselves are always at a temperature below their melt temperature. The particles exiting the nozzle 54 are directed toward a surface of a substrate to coat it.

The powder particles used for kinetic spraying in accordance with the present invention generally comprise metals, alloys, ceramics, diamonds and mixtures of these particles. The particles may have an average nominal diameter of from greater than 50 microns to about 200 microns. Preferably the particles have an average nominal diameter of from 50 to 180 microns.

Preferably the main gas pressure using either embodiment of the nozzle 34 is set at from 100 to 400 psi and the main gas temperature is preferably from 200 to 3000° F. Preferably when using the nozzle 34 shown in FIG. 2 the pressure of gas used in the high pressure powder feeder 30 is from 25 to 75 psi above the main gas pressure as measured at the pressure sensor 46. The stand off distance between the exit end 60 and the substrate is preferably from 0.5 to 12 inches, more preferably from 0.5 to 7 inches and most preferably from 0.5 to 3 inches. The traverse rate of the nozzle 34 and the substrate relative to each other is preferably from 25 to 2500 millimeters per second, more preferably from 25 to 250 millimeters per second, and most preferably from 50 to 150 millimeters per second. Preferably the powder particles are feed to the nozzle 34 at a rate of from about 10 to 60 grams per minute. The preferred particle velocities range from about 300 to 1200 meters per second.

The system 10 can be used to coat a wide variety of substrate materials including alloys, metals, ceramics, woods, dielectrics, semiconductors, polymers, plastics, and mixtures of these materials.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A converging diverging supersonic nozzle for a kinetic spray system comprising:
a supersonic nozzle comprising a first end opposite an exit end and a diverging region adjacent said exit end;
a removable throat insert comprising an entrance cone and a throat; and
said removable throat insert received in said first end with said throat positioned adjacent said diverging region.

2. The nozzle as recited in claim 1 wherein said insert is formed from an alloy, a hardened alloy, a metal, a hardened metal, or a ceramic material.

3. The nozzle as recited in claim 1 wherein the largest interior diameter of said entrance cone is from 6 to 10 millimeters.

4. The nozzle as recited in claim 1 wherein said throat has an interior diameter of from 1 to 6 millimeters.

5. The nozzle as recited in claim 1 wherein said throat has an interior diameter of from 2 to 4 millimeters.

6. The nozzle as recited in claim 1 wherein said diverging region has a length of from 100 to 400 millimeters.

7. The nozzle as recited in claim 1 wherein said exit end has a rectangular interior shape with a short dimension of from 2 to 6 millimeters and a long dimension of from 8 to 14 millimeters.

8. A converging diverging supersonic nozzle for a kinetic spray system comprising:
a supersonic nozzle comprising a first end opposite an exit end and a diverging region adjacent said exit end;
a removable throat insert comprising an entrance cone, a diverging region and a throat positioned between said entrance cone and said diverging region; and
said removable throat insert received in said first end with said diverging region of said insert positioned adjacent said diverging region of said nozzle.

9. The nozzle as recited in claim 8 wherein said insert is formed from an alloy, a hardened alloy, a metal, a hardened metal, or a ceramic material.

10. The nozzle as recited in claim 8 wherein the largest interior diameter of said entrance cone is from 6 to 10 millimeters.

11. The nozzle as recited in claim 8 wherein said throat has an interior diameter of from 1 to 6 millimeters.

12. The nozzle as recited in claim 8 wherein said throat has an interior diameter of from 2 to 4 millimeters.

13. The nozzle as recited in claim 8 wherein said diverging region of said insert has a length of from 10 to 300 millimeters.

14. The nozzle as recited in claim 8 wherein said diverging region of said insert has a length of from 20 to 250 millimeters.

15. The nozzle as recited in claim 8 wherein said insert further includes an alignment feature to align said insert as it is received in said first end.

16. The nozzle as recited in claim 8 wherein said insert further includes a hole in said diverging region of said insert for receiving an injector tube.

17. A replaceable throat insert for a supersonic nozzle comprising:
an entrance cone and a throat, said insert removably receivable in a first end of a supersonic nozzle.

18. The insert as recited in claim 17 wherein said insert is formed from an alloy, a hardened alloy, a metal, a hardened metal, or a ceramic material.

19. The insert as recited in claim 17 wherein the largest interior diameter of said entrance cone is from 6 to 10 millimeters.

20. The insert as recited in claim 17 wherein said throat has an interior diameter of from 1 to 6 millimeters.

21. The insert as recited in claim 17 wherein said throat has an interior diameter of from 2 to 4 millimeters.

22. The insert as recited in claim 17 further comprising a diverging region with said throat positioned between said entrance cone and said diverging region.

23. The insert as recited in claim 22 wherein said insert further includes an alignment feature.

24. The insert as recited in claim 22 wherein said insert further includes a hole in said diverging region, said hole for receiving an injector tube.

25. The insert as recited in claim 22 wherein said diverging region has a length of from 10 to 300 millimeters.

26. The insert as recited in claim 22 wherein said diverging region has a length of from 20 to 250 millimeters.
